(19) United States
(12) Patent Application Publication
(10) Pub. No.: US 2004/0140772 A1
(43) Pub. Date: Jul. 22, 2004

(54) System and process for providing a display arrangement on a device that may be limited by an intrinsic safety barrier

(76) Inventors: Geraldo Gullo, Sertaozinho (BR); Basillio Selli, Nesconset, NY (US)

Correspondence Address: BAKER & BOTTS, 30 ROCKEFELLER PLAZA, NEW YORK, NY, 10112

(21) Appl. No.: 10/348,463

(22) Filed: Jan. 21, 2003

(51) Int. Cl. G09G 3/36

(52) U.S. Cl. 315/100; 315/276

(57) ABSTRACT

An arrangement and method are provided to avail information visible at an observation location is provided. The arrangement includes a sensor adapted to sense at least one process parameter and a display for providing a visual representation of the at least one process parameter received from the sensor. The sensor can be electrically limited by an intrinsically safe barrier, and is capable of being powered in accordance with a fieldbus protocol. The display is electrically limited by an intrinsically safe barrier, and is capable of being powered in accordance with the fieldbus protocol. The display may include a light producing device for generating light and an intermediary (or light blocking) layer. The intermediary layer can be positioned closer to the observation location than the light producing device, and may be configured to selectively block or reduce the intensity of a portion of the light generated by the light producing device.

### FIELD OF THE INVENTION

The present invention relates generally to systems and methods for displaying information within a manufacturing environment. More particularly, the inventor relates to a system and method for displaying information using a backlit display within a hazardous area of a manufacturing environment in which intrinsically safe barriers are utilized.

### BACKGROUND OF THE INVENTION

In industrial processes where flammable or explosive materials are handled any leak or spill can cause an explosive and dangerous atmosphere. These conditions occur in many industrial environments, and more typically in those involving petroleum and other chemicals, process gasses, metal and carbon dust, alcohol, grain, starch, flour and fibers. To protect personnel and plant, precautions should be taken within these hazardous areas. In the past, pneumatic controls have been used in such areas to avoid the risk that an electrical spark may pose. Currently, while pneumatic equipment is still utilized, new technologies and engineering advances have created a wide range of electrical controls which allow for a far greater functionality, and still maintain a safe operating environment within such hazardous areas.

Many of these technologies, as they apply to process measurement and control, are associated with an area of engineering known as “Intrinsic Safety.” An Intrinsic Safety methodology describes a placement of an energy-limiting interface electrically between safe and hazardous areas. These energy-limiting interface and placement thereof restricts the electrical energy in the hazardous-area circuits so that potential electrical sparks or hot spots are too limited and weak to cause any ignition. Consequently, such limiting of the types of electrical devices that can be used in the hazardous area to those devices that can operate under highly restrictive electrical constraints.

An intrinsic safety barrier is a device typically placed in a non-hazardous location (or in a safe location) which permits the electrical interconnection of the devices located in a hazardous area. In particular, the intrinsically safe barrier limits the power that can be introduced into the hazardous location to energy levels which are safe for the material being handled (or the process being performed) in such area. This barrier protects against, e.g., fault conditions such as shorting of the wires that are connected to the hazardous area side of the barrier by grounding the wires connected to the hazardous area side of such barrier, therefore preventing a misconnection or failure of the power supply which allows an unsafe voltage to be applied to the safe area side of the barrier.

In a particular factory within which hazardous conditions may exist, a conventional arrangement can be provided that includes intrinsically safe barrier which limits a portion of the power grid of the factory from an array of sensors located throughout the factory. The sensors are generally located throughout the hazardous area of the factory. Each of the sensors is connected to the intrinsically safe barrier in order to receive power. A section of the sensors may also be directly coupled to a display so as to communicate data and readings of the sensors to technicians working in the hazardous area of the factory. In particular, the technicians working in the hazardous area of the factory can collect readings from the sensors of the sensor array by shining a flashlight at the display, and reading the displayed data from such display. This display may include a thin film transistor layer and a reflective layer. The thin film transistor layer prevents light from the flashlight from being reflected back to the technician, thereby creating dark areas of the display. While this system can be adequately used for displaying data to technicians throughout the factory, the technicians are generally required to carry flashlights, locate the sensor displays (potentially placed in dark areas of the factory) and illuminate the flashlight at each display so as to view the displayed data.

Certain publications relate to devices and systems utilizing particular displays and sensing equipment. For example, U.S. Pat. No. 5,655,841 describes a measurement system having a temperature sensor, a level encoder, a flow sensor and pressure sensors. The level sensor output may be sent to a transmitter. The transmitter is housed in an enclosure, and the ends of the enclosure are closed off. Input and output lines enter the transmitter through the rear cover, and are connected to the transmitter circuitry via an intrinsically safe barrier termination assembly. A liquid crystal display readout is provided in the enclosure. In addition, the liquid crystal display can be backlit.

Another publication, i.e., U.S. Pat. No. 5,854,617 describes a backlight luminescence control device for use in a portable computer to control a backlight of a liquid crystal display. A cold-cathode fluorescent backlight lamp (CCFL) is provided as a light irradiating unit for backlighting the liquid crystal display. A backlight drive circuit is connected to the microcontroller to drive the CCFL with the appropriate luminescence level according to the battery voltage level measured from the battery.

Furthermore, U.S. Pat. No. 6,144,359 describes an avionics display device for use in the cockpit of an aircraft. The display device includes a liquid crystal display for using a source of light to display information to a viewer and a backlight adapted to controllably provide a variable portion of the source of light for use by the liquid crystal display in displaying the information. An ambient light sensor adapted to sense an intensity level of ambient light in the cockpit of the aircraft provides a sensor output indicative of the sensed ambient light level. Luminance control circuitry coupled to the ambient light sensor receives the sensor output, and generates as a function of the sensed ambient light level control signals for increasing or decreasing the portion of the source light provided as the backlight.

Also, U.S. Pat. No. 6,433,791 describes a displaceable display and a method for controlling an output of a display unit. The displaceable display may be a liquid crystal display or a light emitting diode display.

However, none of these publications disclose a backlit display which can be placed in a hazardous and/or fieldbus environment. In particular, the publication do not describe such displays whose components can be intrinsically limited, or controlled using a fieldbus protocol. Such display could facilitate the viewing of the information illustrated thereon from a distance (e.g., in a safe environment), even when the display is situated in a dark area.

### OBJECTS AND SUMMARY OF THE INVENTION

An object of the present invention is to provide a backlight display which is configured to be located at or near a sensor within a hazardous area, with the sensor and backlight display being limited from control circuitry and a power source by an intrinsically safe barrier. Another object of the present invention is to provide a system in which the backlight display can be located at or near a sensor which derives all power and control signals in accordance with the fieldbus (e.g., Foundation® Fieldbus, Profibus®, etc.) protocol.

Accordingly, a system, display arrangement and method are provided to address at least some, if not all, of these objects. This backlit display arrangement provides information visible at an observation location and includes a light producing device and a light blocking layer. The light producing device is provided for creating light, and is electrically limited by an intrinsically safe barrier: The light blocking layer can be situated at a position between the observation location of the display arrangement and the light producing device. This layer is electrically limited by the intrinsically safe barrier, and is capable of blocking at least a portion of the light generated by the light producing device.

In another exemplary embodiment of the present invention, the backlight display arrangement includes a light producing device and a light blocking layer. The light producing device is a light source which is adapted to generate light. The light blocking layer can be situated at a position between the observation location and the light producing device, and is capable of blocking at least a portion of the light that is generated by the light producing device. The light blocking layer and the light producing device are capable of drawing power in accordance with the fieldbus protocol.

In yet another exemplary embodiment of the present invention, an arrangement electrically limited by an intrinsically safe barrier for providing information visible at an observation location can be provided. This arrangement may include a sensor adapted to sense at least one process parameter and a backlit display for providing a visual representation of the at least one process parameter received from the sensor. The backlit display can include a light producing device for creating light and a light blocking layer positioned closer to the observation location than the light producing device.

In still another exemplary embodiment of the present invention, an arrangement for providing information visible at an observation location is provided. The arrangement may include a sensor adapted to sense at least one process parameter and capable of drawing power in accordance with the fieldbus protocol. The arrangement can also have a backlit display for providing a visual representation of the at least one process parameter received from the sensor. The backlit display is capable of drawing power in accordance with the fieldbus protocol. Similarly to other embodiments, the backlit display can include a light producing device for creating light and a light blocking layer.

According to a further embodiment of the present invention, a method for providing information visible at an observation location via a backlight display is provided. The method can provide light in an area electrically limited by an intrinsically safe barrier, and block at least a portion of the produced light at a position between the observation location and the light producing device in an area electrically limited by an intrinsically safe barrier.

In a still further exemplary embodiment of the present invention, a method for providing information visible at an observation location via a backlight display is provided. The method produces light in accordance with the fieldbus protocol. Then, at least a portion of the produced light can be blocked at a position between the observation location and the light producing device also in accordance with the fieldbus protocol.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a block diagram of an exemplary embodiment of a monitoring system according to the present invention;

FIG. 2 is a circuit diagram of an exemplary embodiment of a communication and control logic assembly of the monitoring system of FIG. 1;

FIG. 3 is a circuit diagram of an exemplary embodiment of an intrinsically safe barrier of the monitoring system of FIG. 1;

FIG. 4 is a circuit view of an exemplary embodiment of a sensor array of the monitoring system of FIG. 1;

FIG. 4 is a perspective drawing of an exemplary embodiment of a backlight display of a sensor of the sensor array of FIG. 1;

FIG. 5a is circuit diagram of an exemplary embodiment of a backlight display of the sensor of FIG. 4; and

FIG. 5b is circuit diagram of a second exemplary embodiment of a backlight display of the sensor of the sensor array of FIG. 4.

Throughout the figures, the same reference numerals and characters, unless otherwise stated, are used to denote like features, elements, components or portions of the illustrated embodiments. Moreover, while the present invention will now be described in detail with reference to the drawings, it is done so in connection with the illustrative embodiments. It is intended that the changes and modifications can be made to the described embodiments without departing from the true scope and spirit of the subject invention as defined by the appended claims.

### DETAILED DESCRIPTION OF PREFERRED EMBODIMENTS

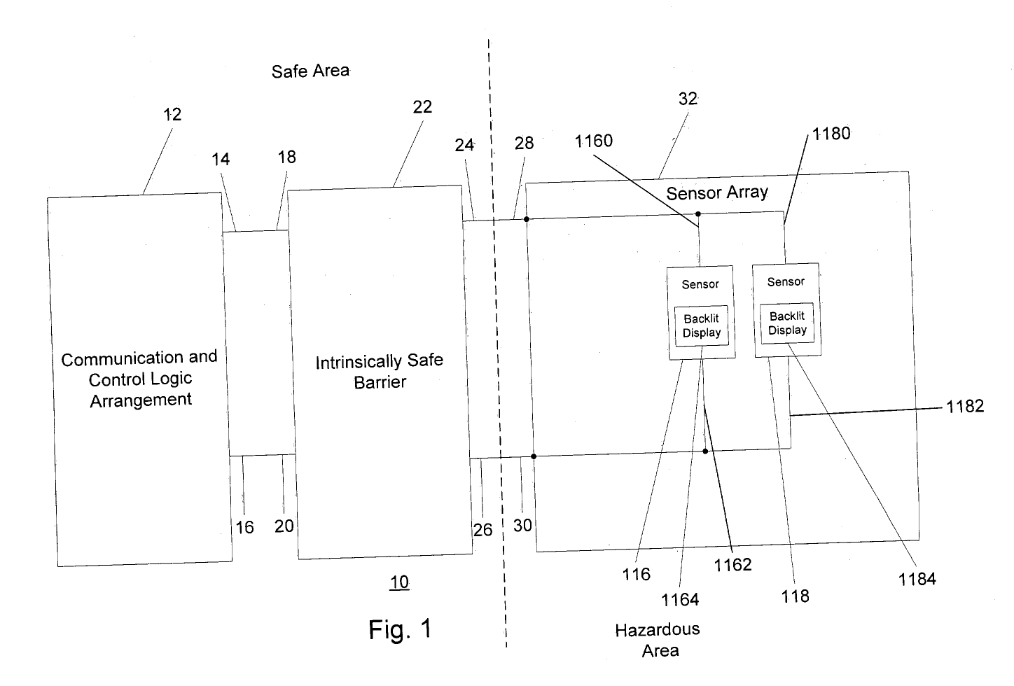

FIG. 1 illustrates a block diagram of an exemplary embodiment of a monitoring system 10 for sensing various process parameters and variables and displaying those measurements on various backlight displays, according to the present invention. The monitoring system 10 utilizes a communication and control logic arrangement 12, an intrinsically safe barrier 22 and a sensor array 32 to measure and display various process parameters. The exemplary sensor array 32 may include a first sensor 116 having a backlight display 1164 and a second sensor 118 having a backlight display 1184. It should be understood that the sensor array 32 can have a single sensor or more than two sensors that are shown in FIG. 1.

The communication and control logic arrangement 12 preferably provides power for the monitoring system 10, issues commands to the sensor array 32, and receives information regarding various process parameters and variables from the sensor array 32. For example, the communication and control logic arrangement 12 can include a microprocessor (e.g., Pentium®), which executes instructions to perform the functions described herein. The communication and control logic arrangement 12 also includes a first terminal 14 and a second terminal 16 which are connected to a first terminal 18 and a second terminal 20, respectively, of the intrinsically safe barrier 22. The intrinsically safe barrier 22 electrically limits (e.g., isolates) and protects a particular area (e.g., a protected area) in which no electric sparks are desired. Such electrical limiting can include the limiting of the current and/or voltage within the protected area. In the monitoring system 10, the sensor array 32 is likely located in the protected area, and the communication and control logic arrangement 12 and the intrinsically safe barrier 22 are located outside the protected area. The intrinsically safe barrier 22 also includes a third terminal 24 and a fourth terminal 26 which are connected to a first terminal 28 and a second terminal 30, respectively, of the sensor array 32. The sensors of the sensor array 32 preferably measure and display the measurements of various process parameters (for example, temperature, pressure, humidity, etc.). These various sensors in the sensor array 32 can utilize a backlight display to display the measurements the various process parameters. These various sensors in the sensor array 32 may also utilize a communications protocol, such as Foundation® Fieldbus or Profibus® protocols, to transmit a digital representation of the measured parameters to the communication and control logic arrangement 12 via the intrinsically safe barrier 22.

In particular, the exemplary sensor array 32 of FIG. 1 includes the first terminal 28, the second terminal 30, the first sensor 116 and the second sensor 118. The first terminal 28 of the sensor array 32, a first terminal 1160 of the first sensor 116 and a first terminal 1180 of the second sensor 118 are electrically connected to one another. In addition, the second terminal 30 of the sensor array 32, a second terminal 1162 of the sensor 116 and a second terminal 1182 of the sensor 118 are electrically connected to one another. The first sensor 116 includes a backlight display 1164. The backlight display 1164 can be used to display information collected or received by the first sensor 116. Similarly, the second sensor 118 includes a backlight display 1184, and uses this display 1184 to display information collected or received by the second sensor 118. The first and second sensors 116, 118 of the sensor array 32 are also capable of communicating with the communication and control logic assembly 12 by utilizing a particular communications protocol which is compatible for each such device (e.g., Foundation® Fieldbus or Profibus® protocol). Although the first and second sensors 116, 118 of the sensor array 32 are likely located in the unprotected or hazardous area, and the communication and control logic assembly 12 can be provided in the protected or safe area, the first and second sensors 116, 118 may communicate with the processor 108 using such particular communications protocol via the intrinsically safe barrier 22, and vice versa.

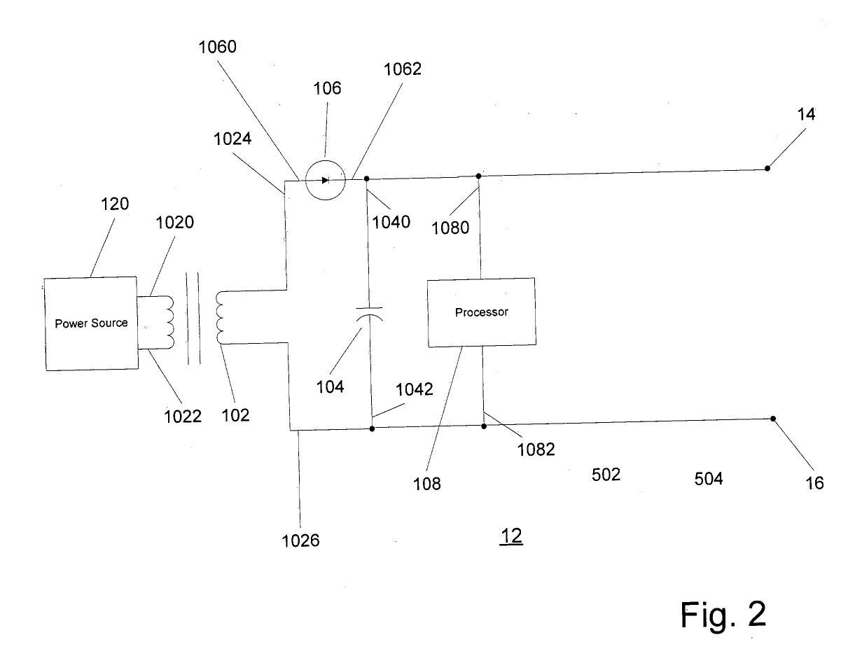

FIG. 2 shows a circuit diagram of an exemplary embodiment of the communication and control logic arrangement 12, which includes the first terminal 14, the second terminal 16, a transformer 102, a capacitor 104, a diode 106 and a processor 108 The transformer 102 of the communication and control logic arrangement 12 can preferably be a power transformer that provides power to the monitoring system 10. A power source or network 120 provides power to the transformer 102 at a first power terminal 1020 and a second power terminal 1022. The transformer 102 also includes a third power terminal 1024 and a fourth power terminal 1026. The third power terminal 1024 of the transformer 102 and an anode 1060 of the diode 106 are electrically interconnected. Also, a cathode 1062 of the diode 106, a first terminal 1040 of the capacitor 104, a first terminal 1080 of the processor 108 and the first terminal 14 of the communication and control logic arrangement 12 are electrically connected to one another. Further, the fourth power terminal 1026 of the transformer 102, a second terminal 1042 of the capacitor 104, a second terminal 1082 of the processor 108, and the second terminal 16 of the communication and control logic arrangement 12 are electrically interconnected. The capacitor 104 preferably acts as a power filtering device for the processor 108 and the intrinsically safe barrier 22 feeding power to the sensor array 32. In this manner, the capacitor 104 (and the diode 106) can be referred to a power arrangement which is preferably directly connected to the processor 108 and to the intrinsically safe barrier 22. The communication and control logic arrangement 12 is preferably powered by the transformer 102 and the capacitor 104. In a particular embodiment of the present invention, the transformer 102 may provide 18V to the monitoring system 10, and the capacitor 104 can be a 1 mF capacitor.

The monitoring system 10 is designed so that the communication and control logic arrangement 12 (while being located physically and electrically outside the protected area) is in communication with the various sensors of the sensor array 32 (which are located on the opposite side of intrinsically safe barrier 22, and provided within the protected area). For example, the processor 108 transmits commands to these various sensors of the sensor array 32 by utilizing a particular communications protocol (e.g., the fieldbus protocol) and receives commands from the various sensors of the sensor array 32 utilizing a communications protocol which is compliant with the protocol of the sensors. In an exemplary embodiment of the present invention, the communications protocol is Foundation® Fieldbus. In another exemplary embodiment, the communications protocol is HART® protocol, PROFIBUS® protocol, etc.

The monitoring system 10 can be limited, e.g., galvanically isolated such that no ground is needed or provided at any portion thereof. By omitting the ground from the monitoring system 10, the processor 108 can draw power from the transformer 102, and communicate with the first and second sensors 116, 118 of the sensor array 32. Additionally, the transformer 102, the capacitor 104, the diode 106, the processor 108, the fuse 110, the zener diode 112 and the resistor 114 can all be situated in a single enclosure to minimize the size of the entire monitoring system 10.

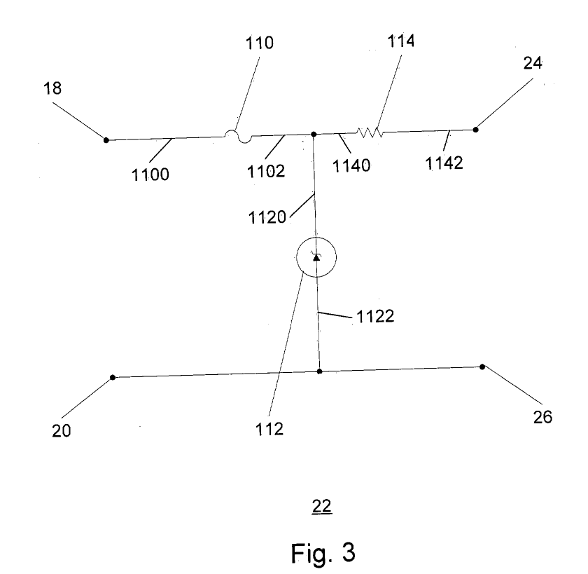

FIG. 3 shows a circuit diagram of an exemplary embodiment of the intrinsically safe barrier 22 of the monitoring system 10 of FIG. 1. Generally, conventional intrinsically safe barriers include an electrical system arrangement which is well known to those having ordinary skill in the art of manufacturing. The intrinsically safe barrier 22 of the present invention electrically limits (e.g., isolates) and protects the protected area (e.g., a hazardous area) by preventing the electrical power from being introduced into the protected area, by e.g., limiting power, current and voltage to certain levels so as to prevent the electric sparks from being generated therein. The sensor array 32 is located in the protected or hazardous area, and the communication and control logic arrangement 12 and the intrinsically safe barrier 22 are situated outside of the protected or safe area.

The exemplary intrinsically safe barrier 22 of FIG. 3 includes the first terminal 18, the second terminal 20, the third terminal 24, the fourth terminal 26, a fuse 110, a zener diode 112 and a resistor 114. The first terminal 18 of the intrinsically safe barrier 22 and a first terminal 1100 of the fuse 110 are electrically interconnected. The fuse 110 acts as a current limiter of the voltage across the zener diode 112. The fuse 110 can “blowout” to create an open circuit between the first terminal 1100 and a second terminal 1102 of the fuse 110 if the voltage provided across the fuse 110 and the zener diode 112 exceeds a predetermined amount. The second terminal 1102 of the fuse 110, a cathode 1120 of the zener diode 112 and a first terminal 1140 of the resistor 114 are electrically interconnected to one another. A second terminal 1142 of the resistor 114 is electrically connected to the third terminal 24 of the intrinsically safe barrier 22. In addition, an anode 1122 of the zener diode 112, the second terminal 20 of the intrinsically safe barrier 22, and the fourth terminal 26 of the intrinsically safe barrier 22 are electrically interconnected. With the exemplary configuration shown in FIG. 3 and described herein, the intrinsically safe barrier 22 allows electrical power to be introduced into the protected area, while limiting power, current and voltage to particular levels so as to prevent the electric sparks.

In one exemplary embodiment of the present invention, the predetermined amount of voltage that would likely make the fuse 110 “blowout” is preferably smaller than the zener voltage of the zener diode 112, thereby protecting the zener diode 112 from experiencing an avalanche breakdown. In another exemplary embodiment of the present invention, the zener diode 22 has a zener voltage of, e.g., 18 V. The zener diode 112 and the resistor 114 operate to limit the voltage drop and current flow between the first terminals and the second terminals of the sensors of the sensor array 32 to a second predetermined amount and a third predetermined amount, respectively. In yet another exemplary embodiment of the present invention, the second predetermined amount for the first terminals of the sensors of the array 32 is, e.g., 18V and the third predetermined amount for the second terminals of the sensors of the sensor array 32 is, e.g., 120 mA. In yet another embodiment of the present invention, the resistor 114 is a 100 Ω resistor.

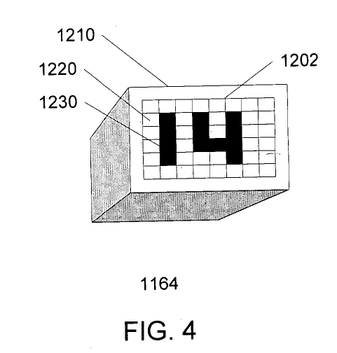

FIG. 4 illustrates an exemplary embodiment of a display 1164 (e.g., a backlit display) of the first sensor 116. The exemplary display 1164 of the first sensor 116 can be substantially identical to a display 1184 of the second sensor 118, and as such, the details of only the display 1164 of the first sensor 116 is described. The display 1184 only differs from the display 1164 in that the display 1184 is operatively connected to the second sensor 118, as such, the display 1184 displays information collected or received by the second sensor 118.

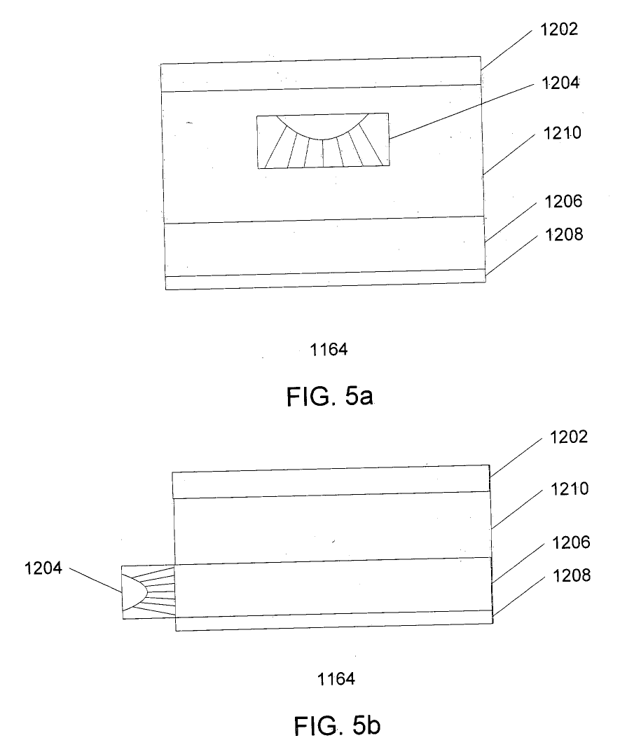

As shown in FIGS. 5a and 5b, the display 1164 of the first sensor 116 includes a light blocking layer 1202, a light source 1204, a light diffusing layer 1206, a light reflective layer 1208 and a display case 1210. The display case 1210 can be composed of a light blocking material, and may include an aperture formed through one of its sides. The exemplary display case 1210 can contain therein the light blocking layer 1202, the light source 1204, the light diffusing layer 1206 and the light reflective layer 1208. The light blocking layer 1202 is placed in registration with the aperture of the backlight display case 1210, and is operatively connected to the first sensor 116. The light blocking layer 1202 is preferably a thin film transistor display, which can include a number of thin film transistors. The first sensor 116 instructs each of the thin film transistors to open or close. If the thin film transistor is open, the light would be allowed to pass unimpeded or filtered through the light blocking layer, for example the thin film transistor 1220 (see FIG. 4). If the thin film transistor is closed, the light will not be allowed to pass unimpeded or filtered through the light blocking layer, for example, a thin film transistor 1230 (see FIG. 4). In this manner, the backlight display 1164 can be made to display information, e.g., shown in FIG. 4 as “14”. In one exemplary embodiment, the light blocking layer 1202 can be a liquid crystal display. It is also possible that instead of blocking the light, the layer 1202 can be configured to reduce the intensity of the light.

FIG. 5a illustrates details of the components of the backlight display 1164 of the first sensor 116. For example and as indicated above, each of the light blocking layer 1202, the light source 1204, the light diffusing layer 1206 and the light reflective layer 1208 are contained within the backlight display case 1210. The light source 1204 is placed adjacent to the light blocking layer 1202. The light source 1204 is oriented such that it generates light away from the light blocking layer 1202 toward the light diffusing layer 1206. The light diffusing layer 1206 is preferably located adjacent to the light source 1204, further away from the light blocking layer 1202. The light diffusing layer 1206 diffuses the light produced by the light source 1204 as it passes through the light diffusing layer 1206 such that the light is dispersed more evenly throughout the light diffusing later 1206. The light reflective layer 1208 is preferably placed adjacent to the light diffusing layer 1206. The light reflecting layer 1208 reflects the diffused light back through the light diffusing layer 1206 which again diffuses the light such that is more evenly diffused throughout the light diffusing layer 1206. In one exemplary embodiment, the light diffusing layer 1206 can be composed of an acrylic material.

Once the light is reflected back through the light diffusing layer 1206, a portion of the light passes through the light blocking layer 1202. The first sensor 116 may configure the light blocking layer 1202 to open specific thin film transistors, and close other thin film transistors, thereby displaying particular desired information. For example, the light blocking layer 1202, as shown in FIG. 4, specifically displays a “14” under the control of the first sensor 116.

Information can be read from the backlight display 1164 even if the light source 1204 is not producing light or the light source is absent from the backlight display case 1210. For example, a technician can shine a flashlight onto the backlight display 1164. The light produced by the flashlight will be diffused by the light diffusing layer 1206, then reflected back through the light diffusing layer 1206 by the light reflecting layer 1208. Once the light is reflected back through the light diffusing layer 1206, a portion of the light passes through the light blocking layer 1202. Again, the first sensor 116 may configure the light blocking layer 1202 to open specific thin film transistors, and close other thin film transistors, so as to display specific information. In one particular embodiment of the present invention, the light source 1204 can be turned on if an alarm condition is satisfied.

FIG. 5b illustrates an alternate embodiment of the backlight display 1164 of the first sensor 116 in greater detail. The alternate embodiment of the backlight display 1164 operates in substantially the same manner as the backlight display 1164 described in relation to FIG. 5a, except for the positioning of the light source 1204. For example the light source 1204 can be positioned adjacent to the light diffusing layer 1206, but not between the light diffusing layer 1206 and the light blocking layer 1202, or between the light diffusing layer 1206 and the light reflecting layer 1208. The light source 1204 can provide the light into the light diffusing layer 1206. The light diffusing layer 1206 diffuses the light produced by the light source 1204 as it passes through the light diffusing layer 1206 such that the light is dispersed more evenly throughout the light diffusing later 1206. A portion of the light produced by the light source 1204 propagates through the light diffusing layer 1206 and through the light blocking layer 1202. Another portion of the light produced by the light source 1204 propagates through the light diffusing layer 1206 to the light reflective layer 1208. The light diffusing later 1206 is positioned between the light reflective layer 1208 and the light blocking layer 1202. The light reflecting layer 1208 reflects the diffused light back through the light diffusing layer 1206, which further diffuses the light as the light propagates through the light blocking layer 1202. Some or all of the light passes through the light blocking layer 1202. As described above with reference to FIG. 5a, the first sensor 116 may configure the light blocking layer 1202 to have specific thin film transistors open and other thin film transistors closed, thereby displaying certain information.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed:

1. A display arrangement for providing information visible at an observation location, comprising:
a light producing device operable to generate light, and electrically limited by an intrinsically safe barrier; and
an intermediary layer provided at a position between the observation location and the light producing device, the intermediary layer being electrically limited by the intrinsically safe barrier, and capable of one of blocking and reducing intensity of at least a portion of the light generated by the light producing device.

2. The arrangement of claim 1, wherein the light producing device includes:
a light source for generating the light, and a light diffusing layer configured to diffuse the light generated by the light source.

3. The arrangement of claim 2, wherein the light diffusing layer is acrylic.

4. The arrangement of claim 2, wherein the light producing device includes a mirror layer configured to reflect the light that is diffused by the light diffusing layer, wherein the acrylic layer is positioned between the light source and the mirror layer, and wherein the mirror layer is positioned at a particular location that is further from the light intermediary layer than the light source.

5. The arrangement of claim 1, wherein the light intermediary layer includes a plurality of thin film transistors.

6. The arrangement of claim 5, wherein each of the thin film transistors is capable of performing one of blocking the light generated by the light producing device, and allowing the light generated by the light producing device to pass therethrough.

7. The arrangement of claim 1, wherein the light intermediary layer is a liquid crystal display.

8. The arrangement of claim 1, wherein the light intermediary layer covers a predefined area.

9. The arrangement of claim 8, wherein the light generated by the light producing device is a diffuse light that is capable of irradiating throughout the predefined area.

10. The arrangement of claim 1, wherein the light blocking layer is prevented from blocking any of the light generated by the light producing device.

11. The display arrangement of claim 1, wherein the light producing device generates the light if an alarm condition is satisfied.

12. A display arrangement for providing information visible at an observation location, comprising:
a light producing device adapted to generate light; and
an intermediary layer provided at a position between the observation location and the light producing device, the intermediary layer capable of one of blocking and reducing an intensity of at least a portion of the light generated by the light producing device, wherein the light blocking layer and the light producing device are capable of being powered in accordance with a fieldbus protocol.

13. The arrangement of claim 12, wherein the light producing device includes:
a light source for generating the light, and
a light diffusing layer configured to diffuse the light generated by the light source.

14. The arrangement of claim 13, wherein the light diffusing layer is acrylic.

15. The arrangement of claim 13, wherein the light producing device further includes a mirror layer for reflecting the light diffused by the light diffusing layer, wherein the acrylic layer is positioned between the light source and the mirror layer, and wherein the mirror layer is provided at a particular location positioned further from the light blocking layer than the light source.

16. The arrangement of claim 12, wherein the light intermediary layer includes a plurality of thin film transistors.

17. The arrangement of claim 16, wherein each of the thin film transistors is capable of performing one of blocking the light generated by the light producing device, and allowing the light generated by the light producing device to pass therethrough.

18. The arrangement of claim 12, wherein the light intermediary layer is a liquid crystal display.

19. The arrangement of claim 12, wherein the light intermediary layer covers a predefined area.

20. The arrangement of claim 19, wherein the light generated by the light producing device is a diffuse light that is capable of irradiating throughout the predefined area.

21. The arrangement of claim 12, wherein the light blocking layer is not prevented from blocking any of the light generated by the light producing device.

22. The arrangement of claim 12, wherein the light producing device generates the light if an alarm condition is satisfied.

23. An arrangement electrically limited by an intrinsically safe barrier for providing information visible at an observation location, comprising:
a sensor adapted to sense at least one process parameter; and
a display for providing a visual representation of the at least one process parameter received from the sensor, the display including:
a light producing device operable to generate light, and
an intermediary blocking layer positioned closer to the observation location than the light producing device, the intermediary layer configured to one of selectively block and reduce an intensity of at least a portion of the light created by the light producing device.

24. The arrangement of claim 23, wherein the light producing device includes:
a light source for generating the light, and
a light diffusing layer configured to diffuse the light generated by the light source.

25. The arrangement of claim 24, wherein the light diffusing layer is acrylic.

26. The arrangement of claim 24, wherein the light producing device includes a mirror layer configured to reflect the light that is diffused by the light diffusing layer, wherein the acrylic layer is positioned between the light source and the mirror layer, and wherein the mirror layer is positioned at a particular location that is further from the light intermediary layer than the light source.

27. The arrangement of claim 23, wherein the light intermediary layer includes a plurality of thin film transistors.

28. The arrangement of claim 27, wherein each of the thin film transistors is capable of performing one of blocking the light generated by the light producing device, and allowing the light generated by the light producing device to pass therethrough.

29. The arrangement of claim 23, wherein the light intermediary layer is a liquid crystal display.

30. The arrangement of claim 23, wherein the light intermediary layer covers a predefined area.

31. The arrangement of claim 30, wherein the light generated by the light producing device is a diffuse light that is capable of irradiating throughout the predefined area.

32. The arrangement of claim 23, wherein the light blocking layer is prevented from blocking any of the light generated by the light producing device.

33. The display arrangement of claim 23, further comprising a communication port configured to transmit a representation of the at least one process parameter received from the sensor to a remote location.

34. The display arrangement of claim 23, wherein the light producing device generates the light if an alarm condition is satisfied.

35. An arrangement for providing information visible at an observation location, comprising:
a sensor adapted to sense at least one process parameter, and capable of receiving power in accordance with a fieldbus protocol; and
a display configured to provide a visual representation of the at least one process parameter received from the sensor, and capable of receiving power in accordance with the fieldbus protocol, the display including:
a light producing device operable to generate light; and
an intermediary positioned closer to the observation location than the light producing device, and configured to one of selectively block and reduce an intensity of at least a portion of the light generated by the light producing device.

36. The arrangement of claim 35, wherein the light producing device includes:
a light source for generating the light, and
a light diffusing layer configured to diffuse the light generated by the light source.

37. The arrangement of claim 36, wherein the light diffusing layer is an acrylic layer.

38. The arrangement of claim 36, wherein the light producing device further includes a mirror layer for reflecting the light diffused by the light diffusing layer, wherein the acrylic layer is positioned between the light source and the mirror layer, and wherein the mirror layer is provided at a particular location positioned further from the light blocking layer than the light source.

39. The arrangement of claim 35, wherein the light intermediary layer includes a plurality of thin film transistors.

40. The arrangement of claim 39, wherein each of the thin film transistors is capable of performing one of blocking the light generated by the light producing device, and allowing the light generated by the light producing device to pass therethrough.

41. The arrangement of claim 35, wherein the light intermediary layer is a liquid crystal display.

42. The arrangement of claim 35, wherein the light intermediary layer covers a predefined area.

43. The arrangement of claim 42, wherein the light generated by the light producing device is a diffuse light that is capable of irradiating throughout the predefined area.

44. The arrangement of claim 35, wherein the light blocking layer is not prevented from blocking any of the light generated by the light producing device.

45. The arrangement of claim 35, further comprising a communications port configured to transmit a representation of the at least one process parameter received from the sensor to a remote location.

46. The arrangement of claim 35, wherein the light producing device generates light if an alarm condition is satisfied.

47. A method for providing information visible at an observation location via a display, comprising:
a) producing light in an area that is electrically limited by an intrinsically safe barrier; and
b) one of blocking and reducing an intensity of at least a portion of the generated light at a position between the observation location and the light producing device in an area electrically limited by the intrinsically safe barrier.

48. The method of claim 47, wherein step (a) includes:
generating the light using a light source, and diffusing the light generated by the light source.

49. The method of claim 48, wherein the light is diffused using an acrylic material.

50. The method of claim 48, wherein step (a) further includes reflecting the diffused light toward the observation location.

51. The method of claim 47, wherein step (b) includes blocking the portion of the light using a plurality of thin film transistors.

52. The method of claim 52, wherein step (b) includes causing each of the thin film transistors to perform one of blocking the light and allowing the light to pass.

53. The method of claim 47, wherein step (b) includes blocking the portion of the light using a liquid crystal display.

54. The method of claim 47, wherein, in step (b), no light is blocked.

55. The method of claim 47, wherein, in step (a), the light is produced if an alarm condition is satisfied.

56. A method for providing information visible at an observation location via a backlight display, comprising:
a) producing light by a light producing device in accordance with the fieldbus protocol; and
b) one of blocking and reducing an intensity of at least a portion of the produced light at a position between the observation location and the light producing device in accordance with the fieldbus protocol.

57. The method of claim 56, wherein step (a) includes:
generating the light using a light source, and
diffusing the light generated by the light source.

58. The method of claim 56, wherein the light is diffused using an acrylic material.

59. The method of claim 56, wherein step (b) includes reflecting the diffused light toward the observation location.

60. The method of claim 56, wherein step (b) includes blocking the portion of the light using a plurality of thin film transistors.

61. The method of claim 61, wherein step (b) includes causing each of the thin film transistors to perform one of blocking the light and allowing the light to pass therethrough.

62. The method of claim 56, wherein step (b) includes blocking the light using a liquid crystal display.

63. The method of claim 56, wherein, in step (b), no light is blocked.

64. The method of claim 56, wherein, in step (a), the light is produced if an alarm condition is satisfied.
